(19) United States
(12) Patent Application Publication
(10) Pub. No.: US 2008/0070461 A1
(43) Pub. Date: Mar. 20, 2008

(54) Shade sheet with predetermined light transmittance and method for manufacturing the same

(76) Inventors: Mao-Sung Chen, Taoyuan County (TW); JuiCheng Kao, Taipei (TW)

Correspondence Address: BACON & THOMAS, PLLC, 625 SLATERS LANE, FOURTH FLOOR, ALEXANDRIA, VA, 22314, US

(21) Appl. No.: 11/523,541

(22) Filed: Sep. 20, 2006

(51) Int. Cl. B32B 5/02; D04B 21/00

(52) U.S. Cl. 442/304; 442/59

(57) ABSTRACT

A method for manufacturing a shade sheet with a predetermined light transmittance includes the following steps: providing knitted fabric with a plurality of pores, dipping the fabric in coating, pressing the fabric socked by the coating, blowing off the coating within the pores to reveal the pores, and baking the fabric stuck with the coating to form and set a shade sheet. The shade sheet is of a predetermined light transmittance because it has a plurality of pores therein.

### FIELD OF THE INVENTION

The present invention relates generally to a shade sheet with a predetermined light transmittance and a method for manufacturing the same, and more particularly to a shade sheet suitable for being used as a curtain, window shade or the like and a method for manufacturing the same.

### BACKGROUND OF THE INVENTION

Window shade sheet may be substantially classified into two categories, i.e., light impermeable shade sheet and light permeable shade sheet. Conventional light impermeable shade sheet is made by coating a mixture of resin, TiO₂ and pigment etc. with high concentrations and viscosities on the opposite faces of a fabric many times by utilizing a scraper so as to stuff all pores in the fabric. However, the conventional light impermeable shade sheet exists disadvantages that the shade sheet has no more tactility of the fabric. Besides, due to thick coating, alligator crack will appear on the shade sheet when the shade sheet is folded so that the pleats formed on the shade sheet cannot be maintained for a long time. Furthermore, because the thick coating is too weighty, the pleats near the lower end are closer than those near the upper end.

As to conventional light permeable shade sheet, when a polyster yarn is drawn out of a drawing board, the yarn is directly passed through polyvinyl chloride (PVC) contained in a trough. Therefore, the polyster yarn is enclosed with PVC and thus a composite yarn is formed. A plurality of composite yarns are arranged respectively as warp yarns and weft yarns to weave into the conventional light permeable shade sheet. The conventional light permeable shade sheet allows light to permeate through since it is manufactured without the coating process and thus has a plurality of pores therein.

Nevertheless, The conventional light permeable shade sheet is not putrescible and thus results in environmental protection problem. Moreover, because PVC is difficult to be permanently set in shape, the conventional light permeable shade sheet is not adapted for pleated curtain, such as Roman window shade. A pleated curtain made by conventional light permeable shade sheet will have the shortcoming that pleats near the lower end are closer than those near the upper end as a result of above feature of PVC and weight of the shade sheet. Besides, undesired fraying or fringe, which deteriorates the sense of value of the shade sheet, often appears at the edge of the conventional light permeable shade sheet on the ground that the conventional sheet is produce by weaving process.

### SUMMARY OF THE INVENTION

Accordingly, the present invention relates to a shade sheet with a predetermined light transmittance and a method for manufacturing the same that is substantially intended to obviate one or more of the problems due to the limitations and disadvantages encountered in the prior art.

One object of the present invention is to provide a shade sheet with a predetermined light transmittance, in which uniform pleats are formed and the pleats are durable.

Another object of the present invention is to provide a shade sheet with a predetermined light transmittance, which will not cause environmental protection problem.

Yet another object of the present invention is to provide a shade sheet with a predetermined light transmittance, which has no undesired fringe and thus appears valuable.

A further object of the present invention is to provide a method for manufacturing a shade sheet with a predetermined light transmittance. The shade sheet made by this method has a predetermined light transmittance, is easy to be formed with uniform and durable pleats, will not cause environmental problem, has no undesired fringe, and has a sense of high value.

Additional features and advantages of the invention will be set forth in the description which follows, and in portion will be apparent from the description, or may be learned by practice of the invention. The objectives and advantages of the invention will be realized and attained by the features as particularly set forth in the written description and claims as well as illustrated in the appended drawings.

To achieve these and other advantages and according to the purpose of the present invention, as embodied and broadly described, a method for manufacturing a shade sheet with a predetermined light transmittance comprises the steps: providing knitted fabric with a plurality of pores; dipping the fabric in coating to stick the coating on the fabric; and blow-drying the fabric along with the coating to reveal the pores on the fabric and set the shade sheet.

Another aspect of the present invention is to provide a shade sheet with a predetermined light transmittance. The shade sheet comprises: a knitted fabric with a plurality of pores; and coating which covers the fabric and reveals the pores on the shade sheet.

Moreover, the blow-drying step further comprises a blowing sub-step and a baking sub-step; the coating in the pores of the fabric is blown off during the blowing sub-step so as to enable the shade sheet having the pores.

It is another preferred feature that the method further comprises a pressing step intervened between the dipping step and the blow-drying step to squeeze the coating into the pores.

Additionally, the fabric is warp-knitted fabric.

Furthermore, an area ratio of the pores to the shade sheet is 3%-25%.

It is preferred that the fabric is knitted by fibers selected from a group of polyster fiber, nylon fiber and polypropylene fiber.

It is preferred that the coating includes 40%-50% of resin, 20%-30% of TiO₂, and water.

It is preferred that the coating further includes 30%-40% of flame retardant, 1%-2.5% of wetting agent, and pigment.

It is preferred that the resin is selected from a group of melamine resin, acrylic resin, urea-formaldehyde resin, and emulsion resin.

It is preferred that the flame retardant is selected from a group of brominated pentaerythriol and polyphosphoricacid ester, and the wetting agent may be selected from a group of alkylaryl ether and polyethylene glycol.

It is to be understood that both the foregoing general description and the following detailed description are exemplary and explanatory and are intended to provide a further non-limiting explanation of the invention as claimed.

### BRIEF DESCRIPTION OF THE DRAWINGS

The accompanying drawings, which are included to provide a further understanding of the invention and constitute a portion of the specification, illustrate embodiments of the invention and together with the description serve to explain the principle of the invention. In the drawings:

FIG. 1 is a schematic view illustrating an apparatus for manufacturing the shade sheet with a predetermined light transmittance according to the present invention; and

FIG. 2 is a plane view illustrating the shade sheet with a predetermined light transmittance according to the present invention.

### DETAILED DESCRIPTION OF THE INVENTION

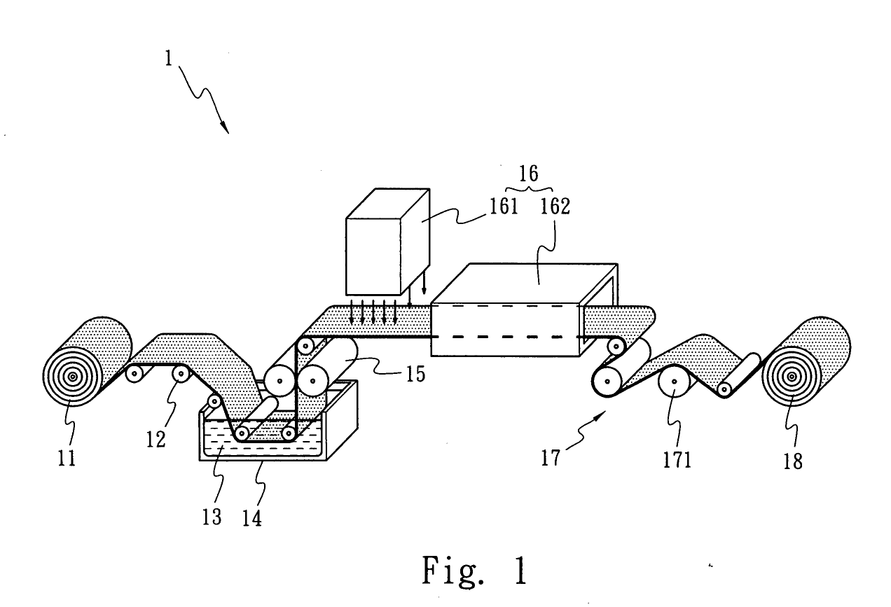

As shown in FIG. 1, the apparatus for manufacturing a shade sheet with a predetermined light transmittance comprises a roll of fabric 11 is drawn out and guided by a plurality of roller 12 and sequentially passed through a trough 14 containing coating 13, a pair of pressing wheel 15, a blow-drying area 16 (for example including a blowing device 161 and a baking device 162), a cooling area 17 (for example including a plurality of cooling wheels 171). Finally, the shade sheet product 18 is rolled for storage or transportation.

According to the operation sequence shown in FIG. 1, the method for manufacturing the shade sheet 18 with a predetermined light transmittance comprises the following steps: providing knitted fabric 11 as a substrate, dipping the fabric substrate 11 in the coating 13, pressing the fabric substrate 11 soaked by coating, blow-drying the substrate soaked by coating (blowing and baking the fabric substrate 11 soaked by the coating for setting), and cooling the fabric substrate 11 soaked by coating etc..

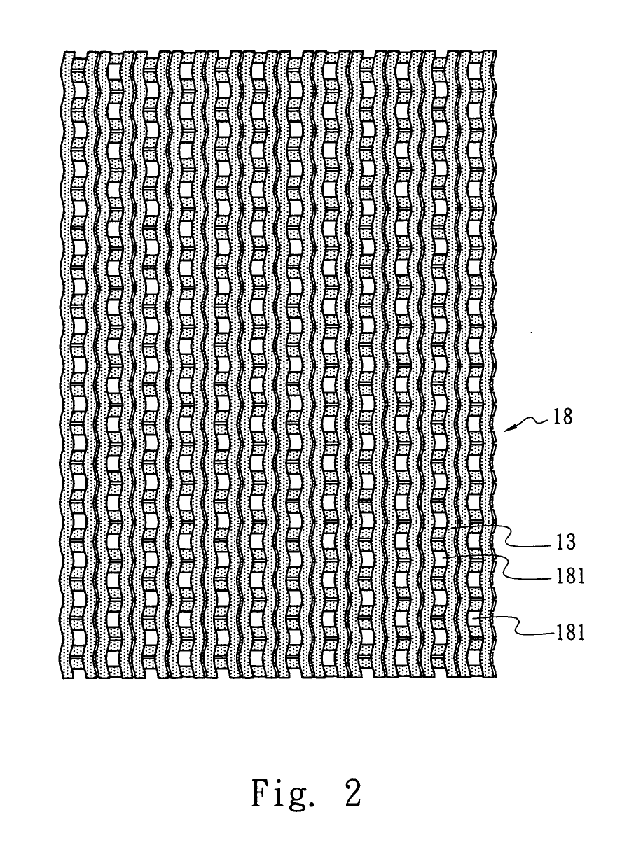

As to the step “providing knitted fabric as a substrate”, knitted fabric 11 or warp-knitted fabric 11 having a plurality of pores 181 (as shown in FIG. 2) is first knitted from fibers or filaments, such as polyster fiber, nylon fiber and polypropylene fiber, by utilizing a conventional knitting machine or warp-knitting machine. The knitted fabric 11 or warp-knitted fabric 11 is then arranged in the apparatus 1 shown in FIG. 1 as the substrate of the shade sheet 18. The pores 181 may be in any geometry, for example the square, rectangular, triangular or circular shape. In addition, the pores 181 may be distributed in the fabric 11 uniformly, regularly, or in the shape of a pattern or graphic. The area ratio of all pores 181 to the entire fabric 11 depends on the desired light transmittance of the shade sheet 18. For example, when the area ratio of the fabric 11 is in the range of 3% to 25%, light transmittance of the shade sheet 18 is about 3% to 25%, or slightly larger.

The structure of the fabric 11 produced by knitting or warp-knitting process is sophisticated other than that produced by weaving process in which warp fibers are simply crossed with weft fibers. Hence, the fringe will not appear at the edge of knitted fabric 11 of warp-knitted fabric 11.

As far as the step “dipping the substrate in the coating”, about 40%-50% by weight of resin, about 20%-30% by weight of Titanium dioxide (TiO₂), about 30%-40% by weight of flame retardant, about 1%-2.5% by weight of wetting agent, appropriate amount of pigment and water are well mixed as the coating 13 in advance. After that, the coating 13 is poured into the trough 14. During the operation of the apparatus 1, the fabric 11 is guided by the rollers 12 and completely dipped into the coating 13 within the trough 14.

The resin in the coating 13 is used for setting the shade sheet 18. The resin may be selected from a group of melamine resin, acrylic resin, urea-formaldehyde resin, and emulsion resin.

TiO₂ is used to add shading effect of the shade sheet 18.

The material of the flame retardant depends on that of the fabric 11. For example, when the fabric 11 is made of polyster fiber, the flame retardant may be selected from a group of brominated pentaerythriol and polyphosphoricacid ester.

The wetting agent is used to enable the shade sheet 18 having the gloss and tactility of the fabric 11 so as to prevent the shade sheet 18 from hardening and embrittling due to the cured coating 13. The wetting agent may be selected from a group of alkylaryl ether and polyethylene glycol.

The color of the pigment mainly determines that of the shade sheet 18 so that proper pigment with desired color may be selected and added into the coating 13.

Amount of added water has to enable the coating 13 with proper concentration or viscosity to be adapted for the operation in subsequent step “blow-drying the substrate soaked by coating”. In contrast to the conventional technique described in the “Background of the Invention”, the concentration or viscosity of the coating 13 used in the present invention is lower to facilitate the coating 13 received within the pores 181 to be blown off by the blowing device 161 during the blow-drying step. However, the scraper used in the conventional technique aims at forcing the coating with higher concentration or viscosity into the pores.

When the fabric 11 is upwards drawn out of the trough 14, some of tiny pores 181 may not be soaked by the coating 13 although the surfaces of the fabric 11 is stuck with the coating 13. Consequently, the fabric 11 soaked by coating 13 has to be pressed by the pair of pressing wheel 15 so as to squeeze the coating 13 sticking on the surface of the fabric 11 into the tiny pores 181 and simultaneously forcing the surplus coating 13 dropping back into the trough 14.

Next, the step of blow-drying the substrate soaked by coating is performed in the blow-drying area 16. The fabric 11 soaked by coating 13 may be blown by hot air directly. Alternatively, this step may be further divided into two sub-steps: blowing step and baking step. During the blowing sub-step, the coating 13 received within the pores 181 is blown off by the air which is sent from the blowing device 161. Accordingly, the pores 181 are revealed in the fabric 11 again to enable the shade sheet 18 to have a predetermined light transmittance. Besides, the forced air also carries some vapor out of the coating 13. Then, the fabric 11 soaked by coating 13 proceeds into the baking device 162 to evaporate water in the coating 13. For example, a heater or infrared emitter (not shown) may be installed in the baking device 162 to provide a zone with about 180 Celsius degrees. The slightly extensible fabric 11 is stretched by the rollers 12 during the steps described above. However, after the fabric 11 exits out of the baking device 162, the fabric 11 is set in shape by dried resin in the coating 13 and then the shade sheet 18 is produced.

The set shade sheet 18 further proceeds and passes through the cooling area 17. A plurality of cooling wheels 171 is arranged within the cooling area 17 to prolong the path for natural cooling. Alternatively, another blowing appliance (not shown) may be equipped in the cooling area 17 to perform forced cooling against the shade sheet 18.

The shade sheet 18 leaving from the cooling area 17 may be winded into a cylinder roll for storage or transportation. Alternative, the shade sheet 17 may be cut into pieces with determined dimensions for being made into curtains or other shades.

This invention has been disclosed in terms of specific embodiments. It will be apparent that many modifications can be made to the disclosed structures without departing from the invention. Therefore, it is the intent of the appended claims to cover all such variations and modifications that are within the breadth and scope of this invention.

What is claimed is:

1. A method for manufacturing a shade sheet with a predetermined light transmittance, the method comprising:
providing knitted fabric with a plurality of pores;
dipping the fabric in coating to stick the coating on the fabric; and
blow-drying the fabric along with the coating to reveal the pores on the fabric and set the shade sheet.

2. The method for manufacturing a shade sheet with a predetermined light transmittance as claimed in the claim 1, wherein the blow-drying step further comprises a blowing sub-step and a baking sub-step; the coating in the pores of the fabric is blown off during the blowing sub-step so as to enable the shade sheet having the pores.

3. The method for manufacturing a shade sheet with a predetermined light transmittance as claimed in the claim 1, wherein the method further comprises a pressing step intervened between the dipping step and the blow-drying step to squeeze the coating into the pores.

4. The method for manufacturing a shade sheet with a predetermined light transmittance as claimed in the claim 1, wherein the fabric is warp-knitted fabric.

5. The method for manufacturing a shade sheet with a predetermined light transmittance as claimed in the claim 1, wherein an area ratio of the pores to the shade sheet is 3%-25%.

6. The method for manufacturing a shade sheet with a predetermined light transmittance as claimed in the claim 5, wherein the fabric is knitted by fibers selected from a group of polyster fiber, nylon fiber and polypropylene fiber.

7. The method for manufacturing a shade sheet with a predetermined light transmittance as claimed in the claim 5, wherein the coating includes 40%-50% of resin, 20%-30% of TiO₂, and water.

8. The method for manufacturing a shade sheet with a predetermined light transmittance as claimed in the claim 7, wherein the coating further includes 30%-40% of flame retardant, 1%-2.5% of wetting agent, and pigment.

9. The method for manufacturing a shade sheet with a predetermined light transmittance as claimed in the claim 8, wherein the resin is selected from a group of melamine resin, acrylic resin, urea-formaldehyde resin, and emulsion resin.

10. The method for manufacturing a shade sheet with a predetermined light transmittance as claimed in the claim 8, wherein the flame retardant is selected from a group of brominated pentaerythriol and polyphosphoricacid ester, and the wetting agent may be selected from a group of alkylaryl ether and polyethylene glycol.

11. A shade sheet with a predetermined light transmittance, the shade sheet comprising:
a knitted fabric with a plurality of pores; and
coating which covers the fabric and reveals the pores on the shade sheet.

12. The shade sheet with a predetermined light transmittance as claimed in the claim 11, wherein the fabric is warp-knitted fabric.

13. The shade sheet with a predetermined light transmittance as claimed in the claim 11, wherein an area ratio of the pores to the shade sheet is 3%-25%.

14. The shade sheet with a predetermined light transmittance as claimed in the claim 13, wherein the fabric is knitted by fibers selected from a group of polyster fiber, nylon fiber and polypropylene fiber.

15. The shade sheet with a predetermined light transmittance as claimed in the claim 13, wherein the coating includes 40%-50% of resin, 20%-30% of TiO₂, and water.

16. The shade sheet with a predetermined light transmittance as claimed in the claim 15, wherein the coating further includes 30%-40% of flame retardant, 1%-2.5% of wetting agent, and pigment.

17. The shade sheet with a predetermined light transmittance as claimed in the claim 16, wherein the resin is selected from a group of melamine resin, acrylic resin, urea-formaldehyde resin, and emulsion resin.

18. The shade sheet with a predetermined light transmittance as claimed in the claim 16, wherein the flame retardant is selected from a group of brominated pentaerythriol and polyphosphoricacid ester, and the wetting agent is selected from a group of alkylaryl ether and polyethylene glycol.
